(19) United States
(12) Patent Application Publication
(10) Pub. No.: US 2011/0111612 A1
(43) Pub. Date: May 12, 2011

(54) ELECTRICAL CONNECTOR ASSEMBLY WITH SEALING WASHER

(75) Inventors: PING-SHENG SU, Tu-Cheng (TW); DA-WEI XING, Kunshan (CN)

(73) Assignee: HON HAI PRECISION INDUSTRY CO., LTD., Tu-Cheng (TW)

(21) Appl. No.: 12/942,019

(22) Filed: Nov. 9, 2010

(30) Foreign Application Priority Data
Nov. 10, 2009 (CN) 200920314496.4

(51) Int. Cl. H01R 13/52

(52) U.S. Cl. 439/271

(57) ABSTRACT

An electrical connector assembly comprises a receptacle connector (100) and a plug connector (200), the receptacle connector (100) has a receptacle housing (11) and a post-shaped contact (12) received in the receptacle housing, and a plug connector (200) has a plug housing (21) and a tube-shaped contact (22) assembled to the plug housing. The plug housing is inserted into the receptacle housing to form a hermetic coupling, and the post-shaped contact is inserted into and electrically connected with the tube-shaped contact. Each of the post-shaped contact and the tube-shaped contact defines an elastic sealing washer (14, 24), and the two sealing washers of the post-shaped contact and the tube-shaped contact are pressed each other to form a sealing combination.

### BACKGROUND OF THE INVENTION

1. Field of the Invention

The present invention generally relates to an electrical connector assembly, and more particularly to an electrical connector assembly for establishing an electrical connection of a photovoltaic module for a solar system.

2. Description of Related Art

As finity of nonrenewable energy resources and development of environmental protection, developing and utilizing solar energy becomes an inevitable trend. Photovoltaic conversion device converts solar radiation to electrical power by solar photovoltaic technology, and the photovoltaic conversion device usually works with semiconductor components, additionally, an electrical connector assembly realizing an electrical connection is required in the conversion and named solar connector.

An conventional electrical connector assembly comprises a plug connector and a receptacle connector, CN patent No. 2817106Y issued to Li on Sep. 13, 2006 discloses an electrical connector assembly having a plug connector and a receptacle connector mating with each other to form an electrical connection. The receptacle connector has a hollow cavity in the front thereof, and a metallic pin is received in the cavity. The plug connector has a hollow tube with a metallic terminal inserted therein, and the plug connector is inserted into the receptacle connector as the metallic pin inserted into the metallic terminal. However, the plug connector is not mating the receptacle connector close enough, there will be a gap between the plug connector and the receptacle connector, but the electrical connector assembly is work in outdoor environment, the electrical connector assembly should be waterproof and dustproof, otherwise the electrical connector will be unstable in electrical connection.

Additionally, the metallic pin of the aforementioned electrical connector assembly is enclosed by a columnar member with a plurality of elastic portions, when the plug connector mating with the receptacle connector again and again, the elastic portions may be deformed after pressed frequently, and the electrical connection between the plug connector and the receptacle connector may be unstable.

Hence, it is desirable to have an improved structure to overcome the above-mentioned disadvantages of the prior art.

### BRIEF SUMMARY OF THE INVENTION

Accordingly, the object of the present invention is to provide an electrical connector assembly with a sealing washer.

In order to achieve the above-mentioned object, an electrical connector assembly comprises a receptacle connector and a plug connector, the receptacle connector has a receptacle housing and a post-shaped contact received in the receptacle housing, and a plug connector has a plug housing and a tube-shaped contact assembled to the plug housing. The plug housing is inserted into the receptacle housing to form a hermetic coupling, and the post-shaped contact is inserted into and electrically connected with the tube-shaped contact. Each of the post-shaped contact and the tube-shaped contact defines an elastic sealing washer, and the two sealing washers of the post-shaped contact and the tube-shaped contact are pressed each other to form a sealing combination.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled view of an electrical connector assembly in accordance with the present invention;

FIG. 2 is similar to FIG. 1, but viewed from another aspect;

FIG. 3 is an exploded, perspective view of a receptacle connector of the cable connector assembly shown in FIG. 1;

FIG. 4 is an exploded, perspective view of a plug connector of the cable connector assembly shown in FIG. 2; and

FIG. 5 is a cross-section view when the plug connector inserted into the receptacle connector of the electrical connector assembly.

### DETAILED DESCRIPTION OF THE INVENTION

Reference will now be made to the drawing figures to describe the present invention in detail.

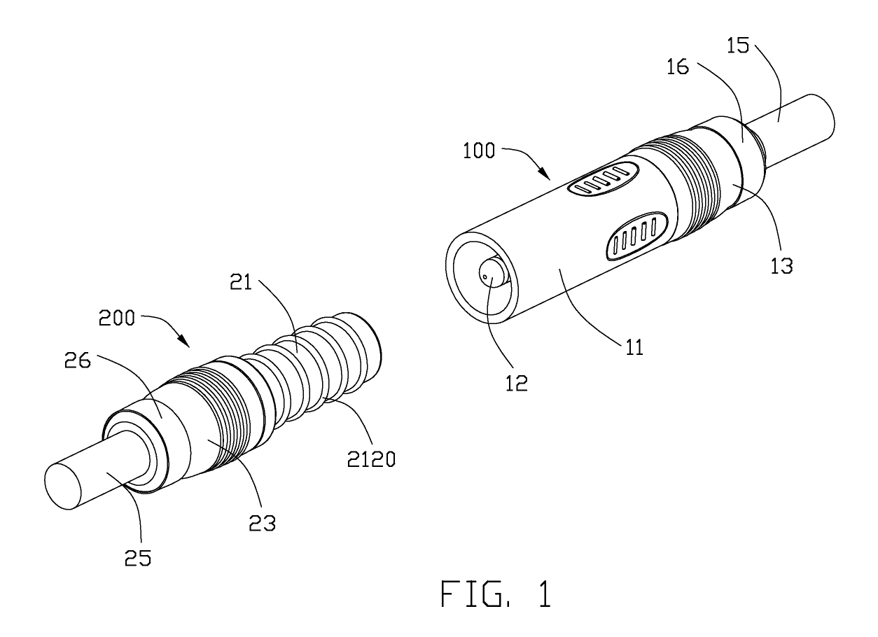

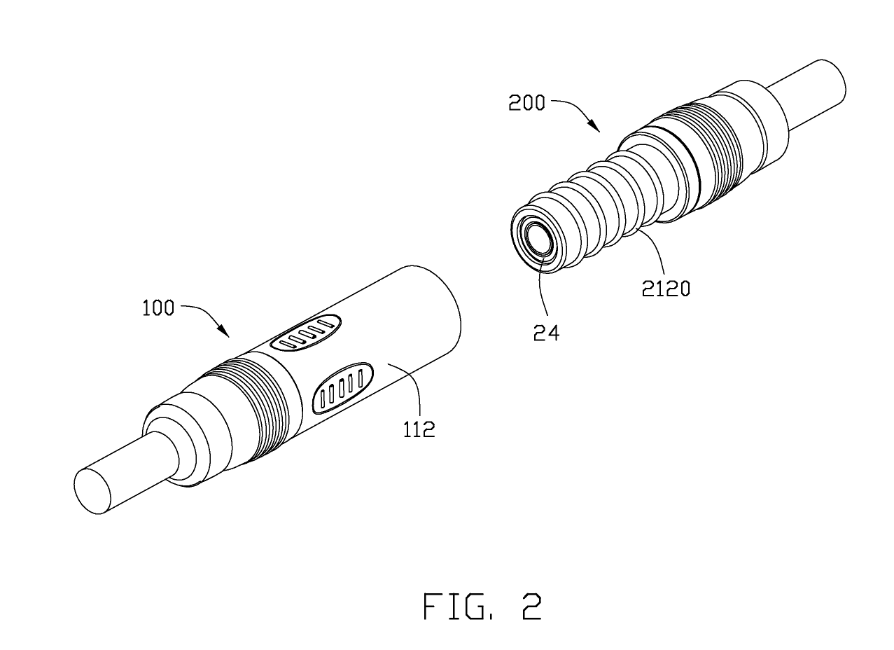

Referring to FIGS. 1-2, an electrical connector assembly made in accordance with the present invention comprises a receptacle connector 100 and a plug connector 200, the receptacle connector 100 has a cavity 110 in the front thereof and a post-shaped contact 12 received in the cavity 110, and the plug connector 200 has a receiving space 210 with a tube-shaped contact 22 received therein.

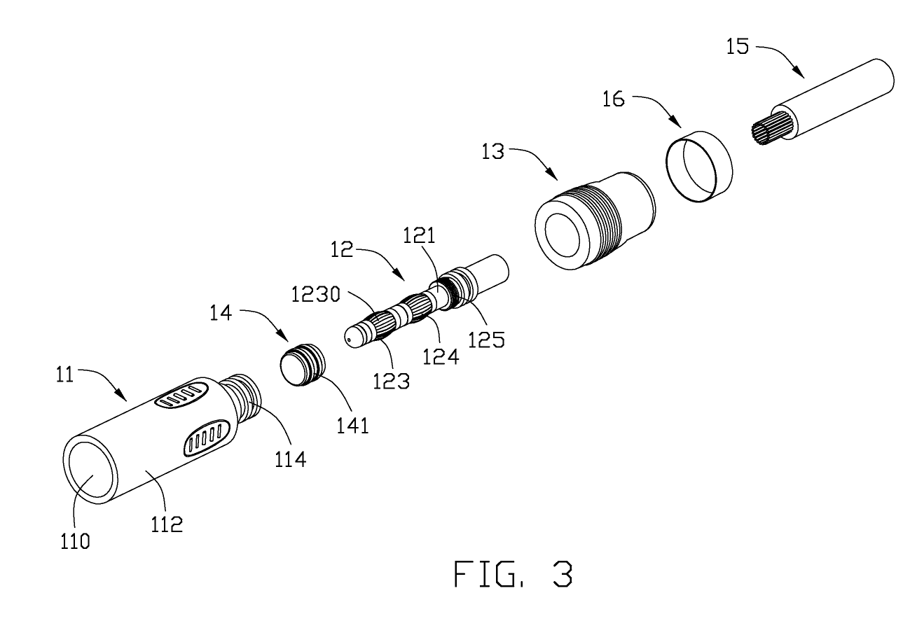

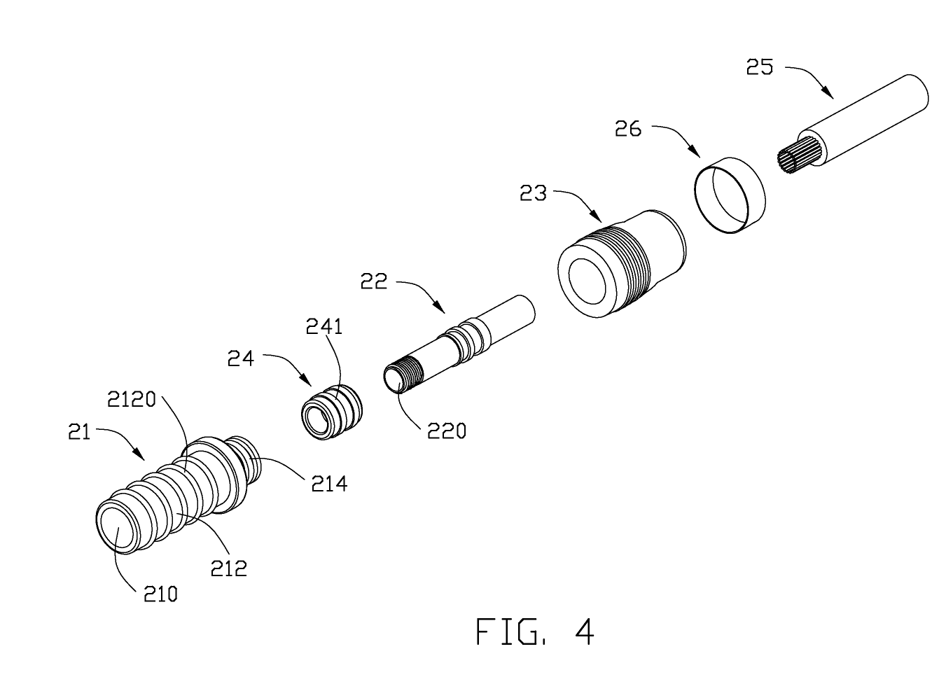

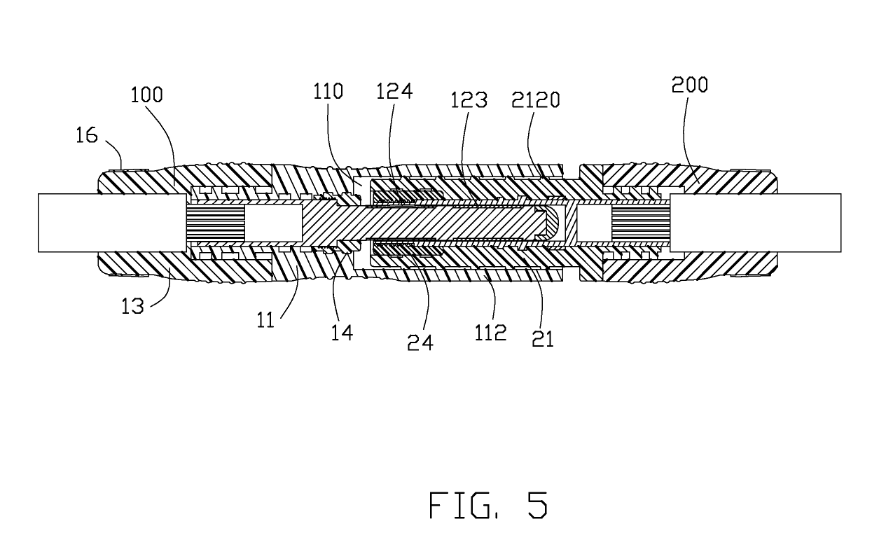

Referring to FIGS. 3-5, the receptacle connector 100 comprises a receptacle housing 11, the post-shaped contact 12 accommodated in the receptacle housing 11, a cover 13 molded over a rear end of the receptacle housing 11, and a cable 15 electrically connected with the post-shaped contact 12. The receptacle housing 11 is made of insulative material, and comprises a cylindrical main portion 112 and a connecting portion 114 extending rearwards from the main portion 112, the diameter of the connecting portion 114 is smaller than the main portion 112. The cavity 110 is recessed from a front end of the main portion 112. The post-shaped contact 12 is made of metallic material and has a columnar body portion 121, a first contacting portion 123 and a second contacting portion 124 surrounding the body portion 121. The first contacting portion 123 is arranged in front of the second contacting portion 124, and has the same configuration as the second contacting portion 124, each of the first contacting portion 123 and the second contacting portion 124 has a plurality of elastic slices 1230 arching outwards. The post-shaped contact 12 defines a retaining portion 125 behind the second contacting portion 124, and the retaining portion 125 is configured with a thread on an exterior surface thereof. The receptacle connector 100 also has an elastic sealing washer 14, and the sealing washer 14 is made of plastic material or rubber and thermoplastic molded over the retaining portion 125 of the post-shaped contact 12. The sealing washer 14 defines a plurality of protrusions 141 extending outwards.

In assembly, the post-shaped contact 12 is connected with wires (not labeled) of the cable 15, and the receptacle housing 11 is molded over the post-shaped contact 12 with the sealing washer 14 thermoplastic molding thereon, the protrusions 141 of the sealing washer 14 are interferentially cooperated with the receptacle housing 11. The cover 13 is assembled to the connecting portion 114 of the receptacle housing 11, and a reinforcing member 16 is of ring shape and enclosing a rear segment of the cover 13 to enhance the intensity between the cover 13 and the cable 15.

The plug connector 200 comprises an insulative plug housing 21, the tube-shaped contact 22 received in the plug housing 21, a cover 23 molded over a rear end of the plug housing 21, and a cable 25 electrically connected with the tube-shaped contact 22. The plug housing 21 comprises a cylindrical base portion 212 and a linking portion 214 extending rearwards from the base portion 212, and the diameter of the linking portion 214 is smaller than the base portion 212. The receiving space 210 is recessed backwards from a front end of the base portion 212. The base portion 212 defines a plurality of projecting portions 2120 extending outwards from an external surface thereof. The tube-shaped contact 22 is made of metallic material and has a passageway 220 accommodating the post-shaped contact 12 of the receptacle connector 100. The tube-shaped contact 22 is enclosing by an elastic sealing washer 24 on a front end thereof, and the sealing washer 24 is made of plastic material or rubber and thermoplastic molded over the post-shaped contact 12, the sealing washer 24 also defines a plurality of protrusions 241 extending outwards.

In assembly, the tube-shaped contact 22 is connected with wires (not labeled) of the cable 25, and the plug housing 21 is molded over the tube-shaped contact 22 with the sealing washer 24 thermoplastic molding thereon, the protrusions 241 of the sealing washer 24 are interferentially cooperated in the receiving space 210. The cover 23 is assembled to the linking portion 214 of the plug housing 21, and another reinforcing member 26 is enclosing a rear segment of the cover 23 to enhance the intensity between the cover 23 and the cable 25.

While the plug connector 200 inserted into the cavity 110 of the receptacle connector 100 along the mating direction, the post-shaped contact 12 of the receptacle connector 100 is inserted into the tube-shaped contact 22 of the plug connector 200 to form an electrical connection therebetween. The first contacting portion 123 of the post-shaped contact 12 is inserted into the passageway 220 of the tube-shaped contact 22 firstly to form an electrical conjunction, and the elastic slices 1230 changes the states thereof from arching outwards to flatly adjacent to an interior wall of the tube-shaped contact 22, as the post-shaped contact 12 inserted into the tube-shaped contact 22, the second contacting portion 124 becomes flatly to be inserted into the passageway 220 and connect with the tube-shaped contact 22, so the receptacle connector 100 can contact and mate with the plug connector 200 enough.

The projecting portions 2120 of the plug connector 200 are adjacent to an inner wall of the cavity 100 of the receptacle connector 100 to realize waterproof and dustproof. The elastic sealing washer 14 of the receptacle connector 100 and the sealing washer 24 of the plug connector 200 are pressed each other to form a sealed combination, therefore the waterproof and dustproof characters thereof can be enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
a receptacle connector having a receptacle housing and a post-shaped contact received in the receptacle housing; and
a plug connector having a plug housing and a tube-shaped contact assembled to the plug housing, the plug housing inserted into the receptacle housing to form a hermetic coupling, and the post-shaped contact inserted into and electrically connected with the tube-shaped contact;
wherein each of the post-shaped contact and the tube-shaped contact defines an elastic sealing washer, and the two sealing washers of the post-shaped contact and the tube-shaped contact are pressed each other to form a sealing combination.

2. The cable connector assembly as claimed in claim 1, wherein the sealing washer of the post-shaped contact is defined near a rear segment thereof.

3. The cable connector assembly as claimed in claim 2, wherein the sealing washer of the plug connector is defined on a front end of the tube-shaped contact.

4. The cable connector assembly as claimed in claim 3, wherein each of the sealing washer defined a plurality of protrusions extending outwards.

5. The cable connector assembly as claimed in claim 1, wherein the post-shaped contact defines at least two contacting portions along a front-to-back direction.

6. The cable connector assembly as claimed in claim 5, wherein each contacting portion comprises a plurality of deflectable slices.

7. A receptacle connector, comprising:
an insulative housing having a cylindrical main portion with a cavity and a connecting portion extending rearwards from the main portion;
a contact received in the insulative housing; and
a cover assembled to the insulative housing and surrounding the connecting portion;
wherein the contact is enclosed by an elastic sealing washer.

8. The receptacle connector as claimed in claim 7, wherein the sealing washer defines a plurality of protrusions extending outwards.

9. The receptacle connector as claimed in claim 8, wherein the contact is of post-shaped, and comprises at least two contacting portions.

10. The receptacle connector as claimed in claim 9, wherein the sealing washer is located behind the contacting portions.

11. An electrical connector assembly comprising:
a receptacle connector including:
a first tubular insulative housing defining opposite outer and inner ring surfaces;
a receptacle contact disposed in the housing and defining a tubular configuration with opposite interior and exterior faces wherein the exterior face circumferentially abuts against the inner ring surface of the first housing;
a plug connector including:
a second tubular insulative housing defining front and rear inner surfaces radially offset from each other wherein said front inner surface is adapted to circumferentially abut against the outer ring surface of the first housing of receptacle connector when mated;
a plug contact disposed in the housing and defining a columnar configuration with opposite rear and front outer surfaces wherein the rear surface constantly circumferentially abuts against the rear inner surface of the second housing while the front outer surface circumferentially abuts against the interior face of the receptacle contact when mated.

12. The electrical connector assembly as claimed in claim 11, wherein the receptacle connector is equipped with an elastic sealing washer essentially located at a front end of first housing and radially sandwiched between the first housing and the receptacle contact.

13. The electrical connector assembly as claimed in claim 11, wherein the plug connector is equipped with an elastic sealing washer essentially located at a boundary between the front inner surface and the rear inner surface of the second housing and radially sandwiched between the second housing and the plug contact.

14. The electrical connector assembly as claimed in claim 13, wherein said elastic sealing washer axially extends forwardly beyond said boundary for confrontation and deformation during mating.

15. The electrical connector assembly as claimed in claim 11, wherein the receptacle connector is equipped with a first elastic sealing washer essentially located at a front end of first housing and radially sandwiched between the first housing and the receptacle contact, the plug connector is equipped with a second elastic sealing washer essentially located at a boundary between the front inner surface and the rear inner surface of the second housing and radially sandwiched between the second housing and the plug contact under condition that said first elastic sealing washer and said second elastic sealing washer are essentially aligned with each other axially.

16. The electrical connector assembly as claimed in claim 15, wherein said second elastic sealing washer axially extends forwardly beyond said boundary for confrontation and deformation by said first elastic sealing washer during mating.
